(19) United States
(12) Patent Application Publication
(10) Pub. No.: US 2025/0353370 A1
(43) Pub. Date: Nov. 20, 2025

(54) Electric Power Take-Off System Assembly

(71) Applicant: Parker-Hannifin Corporation, Cleveland, OH (US)

(72) Inventors: Germano Franzoni, Arlington Heights, IL (US); Barun Acharya, Schaumburg, IL (US)

(21) Appl. No.: 19/209,898

(22) Filed: May 16, 2025

Related U.S. Application Data
(60) Provisional application No. 63/649,017, filed on May 17, 2024.

(51) Int. Cl. B60K 17/28; B60K 11/04

(52) U.S. Cl. CPC B60K 17/28; B60K 11/04

(57) ABSTRACT

An example assembly of an electric power-take off (ePTO) system includes: a housing forming an enclosure therein; an electric motor mounted to the housing inside the enclosure; a motor controller mounted to the housing inside the enclosure; and a hydraulic pump mounted externally to the housing and coupled to the electric.

### CROSS REFERENCE TO RELATED APPLICATION

The present application claims priority to U.S. Provisional Patent Application No. 63/649,017, filed on May 17, 2024, the entire contents of which are herein incorporated by reference as if fully set forth in this description.

### BACKGROUND

Several types of vehicles, such as refuse collection trucks, cranes, etc. include several actuators to operate various implements and functions. As such, these vehicles may include what is called a power-take off system to drive such actuators.

There is a trend to electrify these vehicles. Particularly, an electrified vehicle may have a battery that provides electric power to various vehicle systems. In such electrified vehicles, the power-take off systems can be referred to as electric power-take off (ePTO) systems.

An ePTO is a system that allows vehicles to use electrical energy for operating auxiliary functions (e.g., drive actuators that operate auxiliary functions or implements) of the vehicle. For example, an ePTO may have an electric motor that converts electric power to mechanical power that drives actuators/implements of a vehicle.

An ePTO is an alternative to the traditional PTO, which is driven by a shaft of an internal combustion engine or transmission. Such traditional PTO requires the engine to idle during use, which can produce more exhaust emissions than while driving. An ePTO makes vehicles more environmentally friendly by allowing an engine to turn off, while the electric power is supplied from a battery, for example.

Given the limited space in such vehicles, it may be desirable to configure ePTOs in a compact package that can be readily mounted to a chassis or body of various types of vehicles. It may also be desirable to configure the ePTO to allow direct access to components that may require maintenance or troubleshooting, for example. It may further be desirable to configure the package in a manner that prevents debris from entering into the package and damaging any of its components in harsh environments.

Also, during operation, components of an ePTO may be exposed to high temperatures as the components generate heat during operation. It may thus be desirable in some applications to include a cooling system, while maintaining compactness of the overall packaging of the ePTO.

It is with respect to these and other considerations that the disclosure made herein is presented.

### SUMMARY

The present disclosure describes implementations that relate to an electric power take-off system assembly.

In a first example implementation, the present disclosure describes an assembly. The assembly includes: a housing forming an enclosure therein; an electric motor mounted to the housing inside the enclosure; a motor controller mounted to the housing inside the enclosure; a hydraulic pump mounted externally to the housing and coupled to the electric motor.

In a second example implementation, the present disclosure also describes a vehicle including the assembly of the first example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a perspective view of an assembly of an ePTO system, according to an example implementation.

FIG. 2 illustrates another perspective view of the assembly of FIG. 1 from a different angle, according to an example implementation.

FIG. 3 illustrates a perspective view of the assembly of FIG. 1 without a cover, according to an example implementation.

FIG. 4 is a block diagram of a vehicle having the ePTO system of FIGS. 1-3, according to an example implementation.

### DETAILED DESCRIPTION

Within examples, disclosed herein is an assembly of an ePTO system. The assembly is packaged in an enclosure that is compact to facilitate mounting the ePTO to vehicles with space constraints. The assembly allows direct access to components of the ePTO to facilitate maintenance and troubleshooting. The enclosure can be sealed to protect the components from debris in harsh environments. The assembly further includes a cooling system disposed within the enclosure to thermally manage the ePTO and protect its components from overheating.

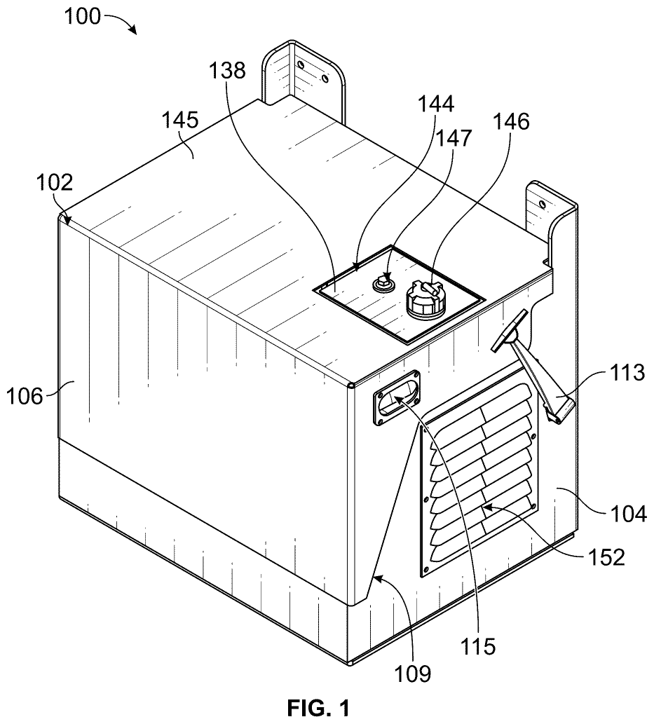

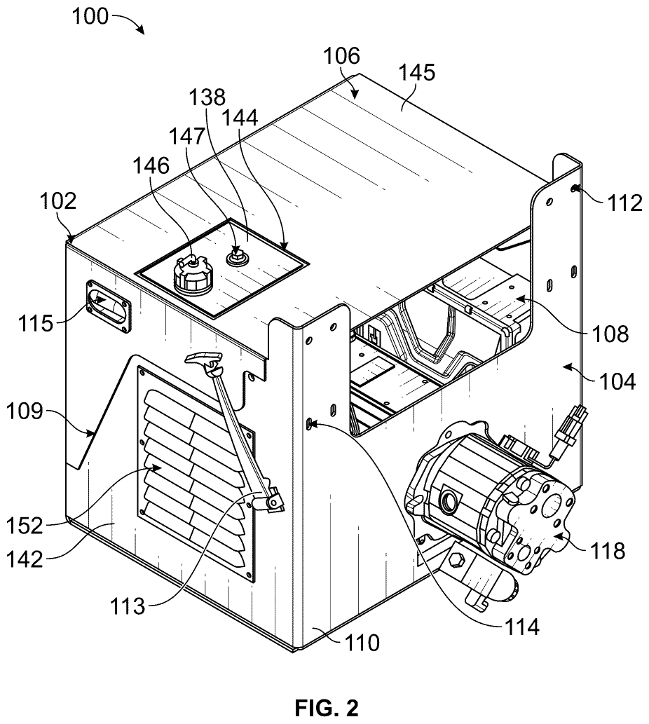

FIG. 1 illustrates a perspective view of an assembly 100 of an ePTO system, and FIG. 2 illustrates another perspective view of the assembly 100 from a different angle according to an example implementation. The assembly 100 represents a package including components of an ePTO system.

Referring to FIGS. 1-2 together, the assembly 100 includes a housing 102 having a base 104 and a cover 106. The cover 106 is mounted to the base 104 as shown to form an enclosure 108 in which some of the components of the ePTO are mounted. A seal 109 can be disposed at the interface between the cover 106 and the base 104 to prevent debris from entering the housing 102.

As shown in FIG. 2, the base 104 has a mounting side 110 that facilitate mounting the assembly 100 to a chassis or body of a vehicle (e.g., a refuse truck). For example, the mounting side 110 can have hole patterns, such as a hole pattern 112 on one side and a hole pattern 114 on the opposite side. In the example implementation of FIG. 2, each hole pattern has four holes; however, other hole patterns configuration with more or fewer holes and different arrangements are contemplated. Fasteners can be disposed through such holes and corresponding holes in a chassis of a vehicle to secure the assembly 100 to the vehicle.

The assembly 100 may have a strap 113 (e.g., a rubber strap) to tie the cover 106 to the base, for example. To perform maintenance or have access to internal components of the assembly 100, the strap 113 can be untied or removed, and then a handle 115 in the cover 106 can be used by a technician to remove the cover and have access to the components mounted within the assembly 100.

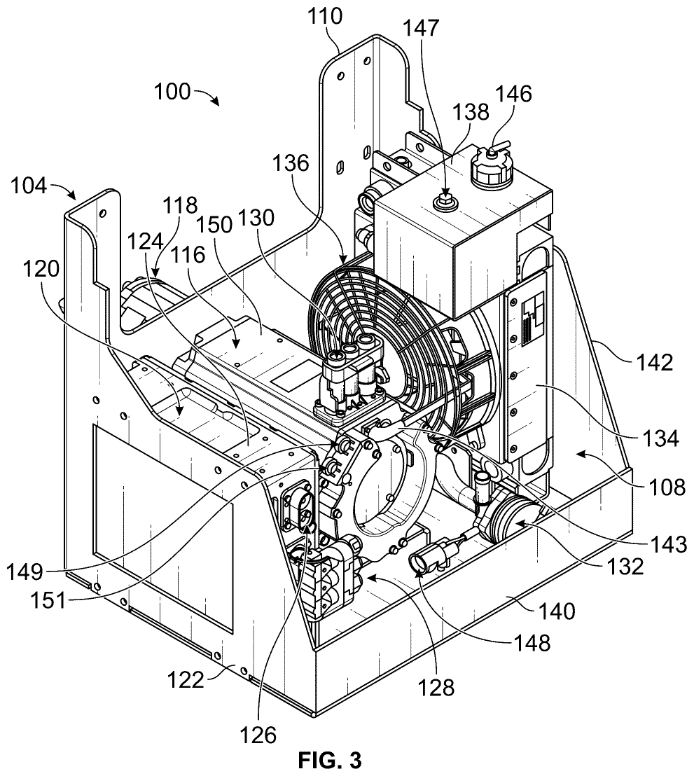

FIG. 3 illustrates a perspective view of the assembly 100 without the cover 106, according to an example implementation. The assembly 100 includes an electric motor 116 mounted in the enclosure 108 to a side of the base 104. In the example implementation of FIG. 3, the electric motor 116 is mounted to an interior surface of the mounting side 110.

Particularly, the mounting side 110 can have an opening through which a motor shaft (output shaft) of the electric motor 116 extends externally outside the housing 102. The assembly 100 further includes a hydraulic pump 118 coupled to, and driven by, the motor shaft of the electric motor 116.

As shown, the hydraulic pump 118 is mounted externally (outside) to the base 104. In particular, the hydraulic pump 118 is attached to an external surface of the mounting side 110. Although the electric motor 116 and the hydraulic pump 118 are shown to be mounted to the mounting side 110, in other implementations, the electric motor 116 and the hydraulic pump 118 can be mounted to other sides of the base 104.

The hydraulic pump 118 can be any type of pump. For example, the hydraulic pump 118 can be a vane, gear, piston, or tandem pump. The hydraulic pump 118 can be fluidly coupled to actuators (e.g., cylinder actuator or hydraulic motors) to provide fluid flow and pressure thereto and drive various implements or functions (e.g., auxiliary functions) of a vehicle. For example, the assembly 100 can provide hydraulic power to a side arm of a truck, an aerial lift hydraulic actuator, etc.

The assembly 100 also includes a motor controller 120 mounted adjacent the electric motor 116, and particularly side by side with respect to the electric motor 116. The motor controller 120 is mounted inside the enclosure 108 (within the housing 102) and is attached to a lateral side 122 of the base 104, and extends parallel to the electric motor 116, as shown.

The motor controller 120 can include a controller housing 124 mounted to the lateral side 122 as shown. The controller housing 124 includes various electronic components and boards therein, for example.

The motor controller 120 can include connectors such as connector 126 and connector 128. The connector 126 can receive a plug of a wire harness of the vehicle to electrically and communicatively couple the motor controller 120 to a vehicle control unit (VCU), for example. This way, the motor controller 120 can communicate with the VCU (receive command signals, provide sensor feedback, etc.). The motor controller 120 may be configured to receive direct current (DC) electric power via the connector 126 from an external power source (not shown) of the vehicle such as an electric generator or a battery.

The motor controller 120 may include one or more printed circuit boards (PCBs). A PCB mechanically supports and electrically connects electronic components (e.g., microprocessors, integrated chips (ICs), capacitors, resistors, etc.) using conductive tracks, pads, and other features etched from one or more sheet layers of copper laminated onto and/or between sheet layers of a non-conductive substrate. Components are generally soldered onto the PCB to both electrically connect and mechanically fasten them to it.

As an example, the motor controller 120 can include at least one processor and an inverter. They can be disposed on different PCBs or integrated into one PCB.

The inverter may include, for example, an arrangement of semiconductor switching elements (transistors) configured as a power converter that converts DC power received from the power source at the inverter (e.g., via the connector 126) to multi-phase (e.g., three-phase), alternating current (AC) power. Such AC power is output via the connector 128. Cables can be connected between the connector 128 and a respective connector 130 of the electric motor 116 to provide the AC power to the wire windings of a stator of the electric motor 116, for example. The cables are not shown to reduce visual clutter in the drawing.

The processor of the motor controller 120 may include a general purpose processor (e.g., a single core microprocessor or a multicore microprocessor), or a special purpose processor (e.g., a digital signal processor, a graphics processor, or an application specific integrated circuit (ASIC) processor). The processor may be configured to execute computer-readable program instructions (CRPI) to perform the operations described throughout herein. The processor may be configured to execute hard-coded functionality in addition to or as an alternative to software-coded functionality (e.g., via CRPI).

The processor is electrically coupled to the inverter. Particularly, the processor can be configured to provide a pulse width modulated (PWM) switching signal to operate the power converter of the inverter, for example.

The motor controller 120 may further include or can be electrically coupled to a precharge circuit and a contactor to facilitate precharging the capacitors of the motor controller 120, while protecting them from inrush currents.

During operation of the assembly 100, heat is generated by the electric motor 116 and the motor controller 120. In some applications, this heat can be damaging to various components of the assembly 100 given the tight spaces. As such, in such applications, the assembly 100 may further include a cooling system to regulate the temperature in the enclosure 108.

Particularly, the assembly 100 may include a coolant pump 132, a heat exchanger 134, a fan 136, and a coolant reservoir 138. The coolant pump 132 is mounted to back side 140 of the base 104, opposite the mounting side 110. The heat exchanger 134 is mounted to a lateral side 142 opposite the lateral side 122 to which the motor controller 120 is mounted such that the electric motor 116 is interposed between the motor controller 120 and the subassembly of the heat exchanger 134 and the fan 136. The fan 136 can be also coupled to the electric motor 116 via a cable 143. (Germano and Barun: what the function of the cable 143 and why is connected between the electric motor and the fan of the heat exchanger).

The coolant reservoir 138 is mounted atop the heat exchanger 134 as shown. Referring to FIGS. 1-2, the cover 106 can have a cutout 144 in a top side 145 of the cover 106. The coolant reservoir 138 protrudes through the cutout 144 to make it readily accessible.

The coolant reservoir 138 has a cap 146 that can be removed to fill the coolant reservoir 138 and inspect coolant level therein, for example. The coolant reservoir 138 may also have an breather cap 147 (e.g., a breather valve cap), which is configured to equalize pressure and prevent contamination within the coolant reservoir 138, allowing air to enter or exit without introducing dirt or moisture. As such, the breather cap 147 may facilitate maintaining proper pressure in the coolant reservoir 138 and prevent pressure buildup that could cause problems.

Referring back to FIG. 3, the coolant pump 132 has a connector 148 that can be electrically coupled to the motor controller 120 or the VCU to receive command signals to operate the coolant system of the assembly 100. For example, if the temperature of the assembly 100 exceeds a threshold temperature, the coolant pump 132 may receive a command signal to turn on and circulate coolant fluid between the coolant reservoir 138, the heat exchanger 134, and the components of the assembly 100 (e.g., the electric motor 116 or the motor controller 120), or the space in the enclosure 108.

For example, a housing 150 of the electric motor 116 can have cooling channels formed therein and fluidly coupled to the heat exchanger 134 via fluid lines (pipes, tubes, or hoses). For instance, the housing 150 of the electric motor 116 may have a coolant inlet fitting 149 to receive coolant from the coolant pump 132 or the heat exchanger 134, and may also have a coolant outlet fitting 151 to discharge coolant.

In examples, the motor controller 120 may also have respective cooling channels and fittings to allow coolant to circulate through the motor controller 120 and absorb heat therefrom. In an example, coolant can be provided to the electric motor 116 then to the motor controller 120 or vice versa, e.g., in a series configuration, or may be provided to them in parallel.

In other examples, the coolant system can include tubes mounted in the enclosure 108 between the internal components of the assembly 100, and such tubes are fluidly coupled to the heat exchanger 134 and the coolant pump 132.

With this configuration, coolant can circulate through the interior of the assembly 100, and/or through housings of the electric motor 116 (and/or the motor controller 120) to absorb heat generated by the components of the assembly 100. Coolant then flows through the heat exchanger 134 where the coolant is cooled via air from the fan 136 to eject heat to an external environment of the assembly 100. Coolant lines (e.g., tubes, hoses, etc.) are not shown in FIG. 3 to reduce visual clutter in the drawing.

As shown in FIGS. 1-2, the lateral side 142 to which the heat exchanger 134 is mounted can have louvers 152. The louvers 152 are configured as slits that allow air flow therethrough as the fan 136 rotates to reduce the temperature of the coolant flowing through the heat exchanger 134 before returning the coolant to the enclosure 108 to absorb heat, and so on.

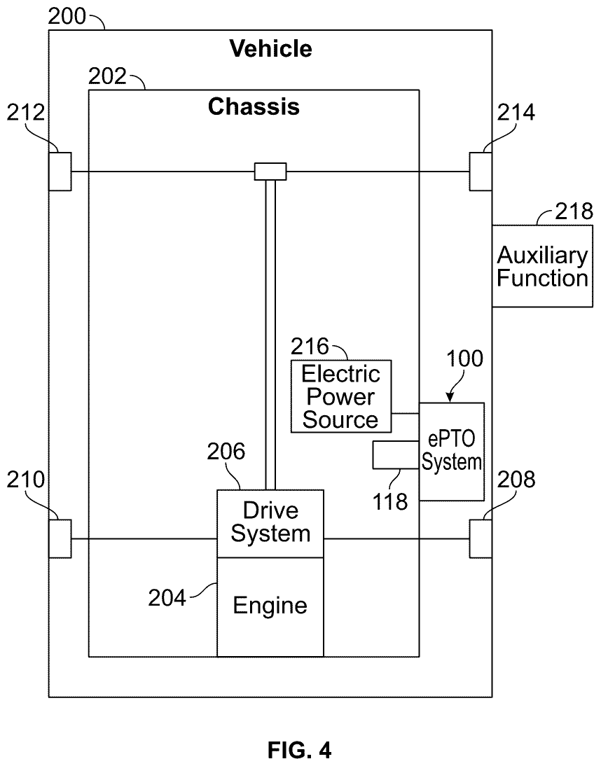

FIG. 4 is a block diagram of a vehicle 200 having the ePTO system of FIGS. 1-3, according to an example implementation. The block diagram is a simplified schematic of the vehicle 200, which can represent any type of vehicle (e.g., dump truck, refuse truck, crane truck, aerial lift, etc.).

The vehicle 200 has a chassis 202 to which an engine 204 may be mounted. The engine 204 drives a drive system 206 (e.g., gearbox), which in turn drives multiple wheels, e.g., wheel 208, wheel 210, wheel 212, and wheel 214.

The vehicle 200 also includes an electric power source 216. In one example, the electric power source 216 can be an electric generator drive by the engine 204. In other examples, the electric power source 216 may be a battery (e.g., a rechargeable battery).

In conventional systems, the chassis of a vehicle may be made by a certain manufacturer and then shipped to a vehicle manufacture or assembler. This occurs because one chassis can be used in multiple types of vehicles (e.g., dump truck, refuse truck, crane truck, aerial lift, etc.). The vehicle manufacture may then install the ePTO system based on the particular needs of the vehicle or manufacturer.

The vehicle manufacture may install the ePTO system external to the body of the vehicle in some cases, exposing the ePTO system to environmental conditions. In other cases, the ePTO system may be installed within the body, but that might complicate maintenance operations.

Advantageously, the assembly 100 can be mounted to the chassis 202 (e.g., to an external side) of the vehicle 200 as shown schematically in FIG. 4. In some examples, the chassis manufacture may provide the chassis with the assembly 100 mounted to the chassis 202 (e.g., via the mounting side 110 and the hole patterns 112, 114) without the hydraulic pump 118. The vehicle manufacturer may then mount any type of pump (e.g., piston pump, vane pump, tandem pump, gear pump, etc.) as desired based on the application. As shown, the hydraulic pump 118 protrudes into the internal space of the chassis 202, for example.

Having to mount the hydraulic pump 118 externally to the housing 102 (e.g., the mounting side 110 of the base 104) of the ePTO system (the assembly 100) is advantageous, as the vehicle manufacturer does not need to open the box or make internal connections. Rather, the hydraulic pump 118 is mounted to the housing 102 and coupled to the output shaft of the electric motor 116, and then hydraulic connections (e.g., fluid lines such as hoses) are made between the hydraulic pump 118 and an auxiliary function 218, and are run along the chassis 202, for example. Hydraulic lines between the hydraulic pump 118 and the auxiliary function 218 are not shown to reduce visual clutter in the drawing.

Similarly, electric wires or cables (e.g., high voltage cables) between the assembly 100 and the electric power source 216, for example, can be run along the chassis 202. With this configuration, in addition to the modularity of the configuration, the hydraulic pump 118 and the various fluid lines and wires are protected from the external environment.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform actuators presented in the figures. In some instances, components of the devices and/or systems may be configured to perform the actuators such that the components are actually configured and structured (with hardware and/or software) to enable such performance. In other examples, components of the devices and/or systems may be arranged to be adapted to, capable of, or suited for performing the actuators, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is an assembly comprising: a housing forming an enclosure therein; an electric motor mounted to the housing inside the enclosure; a motor controller mounted to the housing inside the enclosure; and a hydraulic pump mounted externally to the housing and coupled to the electric motor.

EEE 2 is the assembly of EEE 1, wherein the housing comprises: a cover; and a base.

EEE 3 is the assembly of EEE 2, further comprising: a heat exchanger mounted to the housing inside the enclosure; a fan mounted to the heat exchanger inside the enclosure; a coolant pump mounted to the housing inside the enclosure; and a coolant reservoir mounted in the enclosure, wherein the electric motor, the motor controller, the hydraulic pump, the heat exchanger, and the coolant pump are mounted to the base.

EEE 4 is the assembly of EEE 3, wherein the cover comprises a cutout from which the coolant reservoir protrudes, rendering the coolant reservoir externally accessible.

EEE 5 is the assembly of any of EEEs 1-4, further comprising: a heat exchanger mounted to the housing inside the enclosure, wherein the electric motor is mounted to a first side of the housing, wherein the heat exchanger is mounted to a first lateral side of the housing, and wherein the motor controller is mounted to a second lateral side of the housing opposite the first lateral side, such that the electric motor is interposed between the motor controller and the heat exchanger.

EEE 6 is the assembly of EEE 5, further comprising: a coolant pump mounted to the housing inside the enclosure, wherein the coolant pump is mounted to a second side of the housing opposite the first side.

EEE 7 is the assembly of any of EEEs 5-6, wherein the first side is a mounting side having a hole pattern that facilitates mounting the housing to a chassis of a vehicle.

EEE 8 is the assembly of any of EEEs 5-7, wherein the first lateral side has a plurality of louvers.

EEE 9 is the assembly of any of EEEs 1-8, further comprising: a heat exchanger mounted to the housing inside the enclosure; and a coolant reservoir mounted in the enclosure, wherein the coolant reservoir is mounted to the heat exchanger.

EEE 10 is the assembly of any of EEEs 1-9, wherein the housing has an opening through which a motor shaft of the electric motor extends to be coupled to the hydraulic pump mounted externally to the housing.

EEE 11 is a vehicle comprising: a chassis; an auxiliary actuator an electric power source; and the assembly of any of EEEs 1-10 of an electric power-take off (ePTO) system. For example, the assembly comprises: (i) a housing mounted to the chassis, wherein the housing, (ii) an electric motor mounted inside the housing and electrically coupled to the electric power source, (iii) a motor controller mounted inside the housing, and (iv) a hydraulic pump mounted externally to the housing and coupled to the electric motor.

EEE 12 is the vehicle of EEE 11, wherein the housing of the assembly comprises: a cover; and a base tied to the cover.

EEE 13 is the vehicle of EEE 12, wherein the assembly of the ePTO system further comprises: a heat exchanger mounted inside the housing; a fan mounted to the heat exchanger inside the housing; a coolant pump mounted inside the housing; and a coolant reservoir mounted inside the housing, wherein the electric motor, the motor controller, the hydraulic pump, the heat exchanger, and the coolant pump are mounted to the base.

EEE 14 is the vehicle of EEE 13, wherein the cover comprises a cutout from which the coolant reservoir protrudes, rendering the coolant reservoir externally accessible.

EEE 15 is the vehicle of any of EEEs 11-14, wherein the assembly of the ePTO system further comprises: a heat exchanger mounted inside the housing, wherein the electric motor is mounted to a first side of the housing, wherein the heat exchanger is mounted to a first lateral side of the housing, and wherein the motor controller is mounted to a second lateral side of the housing opposite the first lateral side, such that the electric motor is interposed between the motor controller and the heat exchanger.

EEE 16 is the vehicle of EEE 15, wherein the assembly of the ePTO system further comprises: a coolant pump mounted inside the housing, wherein the coolant pump is mounted to a second side of the housing opposite the first side.

EEE 17 is the vehicle of any of EEEs 15-16, wherein the first side is a mounting side having a hole pattern that facilitates mounting the housing to the chassis.

EEE 18 is the vehicle of any of EEEs 15-17, wherein the first lateral side has a plurality of louvers.

EEE 19 is the vehicle of any of EEEs 11-18, wherein the assembly of the ePTO system further comprises: a heat exchanger mounted inside the housing; and a coolant reservoir mounted in the housing, wherein the coolant reservoir is mounted to the heat exchanger.

EEE 20 is the vehicle of any of EEEs 11-19, wherein the housing has an opening through which a motor shaft of the electric motor extends to be coupled to the hydraulic pump mounted externally to the housing.

What is claimed is:

1. An assembly comprising:
a housing forming an enclosure therein;
an electric motor mounted to the housing inside the enclosure;
a motor controller mounted to the housing inside the enclosure; and
a hydraulic pump mounted externally to the housing and coupled to the electric motor.

2. The assembly of claim 1, wherein the housing comprises:
a cover; and
a base.

3. The assembly of claim 2, further comprising:
a heat exchanger mounted to the housing inside the enclosure;
a fan mounted to the heat exchanger inside the enclosure;
a coolant pump mounted to the housing inside the enclosure; and
a coolant reservoir mounted in the enclosure, wherein the electric motor, the motor controller, the hydraulic pump, the heat exchanger, and the coolant pump are mounted to the base.

4. The assembly of claim 3, wherein the cover comprises a cutout from which the coolant reservoir protrudes, rendering the coolant reservoir externally accessible.

5. The assembly of claim 1, further comprising:
a heat exchanger mounted to the housing inside the enclosure, wherein the electric motor is mounted to a first side of the housing, wherein the heat exchanger is mounted to a first lateral side of the housing, and wherein the motor controller is mounted to a second lateral side of the housing opposite the first lateral side, such that the electric motor is interposed between the motor controller and the heat exchanger.

6. The assembly of claim 5, further comprising:
a coolant pump mounted to the housing inside the enclosure, wherein the coolant pump is mounted to a second side of the housing opposite the first side.

7. The assembly of claim 5, wherein the first side is a mounting side having a hole pattern that facilitates mounting the housing to a chassis of a vehicle.

8. The assembly of claim 5, wherein the first lateral side has a plurality of louvers.

9. The assembly of claim 1, further comprising:
a heat exchanger mounted to the housing inside the enclosure; and
a coolant reservoir mounted in the enclosure, wherein the coolant reservoir is mounted to the heat exchanger.

10. The assembly of claim 1, wherein the housing has an opening through which a motor shaft of the electric motor extends to be coupled to the hydraulic pump mounted externally to the housing.

11. A vehicle comprising:
a chassis;
an auxiliary actuator
an electric power source; and
an assembly of an electric power-take off (ePTO) system comprising: (i) a housing mounted to the chassis, wherein the housing, (ii) an electric motor mounted inside the housing and electrically coupled to the electric power source, (iii) a motor controller mounted inside the housing, and (iv) a hydraulic pump mounted externally to the housing and coupled to the electric motor.

12. The vehicle of claim 11, wherein the housing of the assembly comprises:
a cover; and
a base tied to the cover.

13. The vehicle of claim 12, wherein the assembly of the ePTO system further comprises:
a heat exchanger mounted inside the housing;
a fan mounted to the heat exchanger inside the housing;
a coolant pump mounted inside the housing; and
a coolant reservoir mounted inside the housing, wherein the electric motor, the motor controller, the hydraulic pump, the heat exchanger, and the coolant pump are mounted to the base.

14. The vehicle of claim 13, wherein the cover comprises a cutout from which the coolant reservoir protrudes, rendering the coolant reservoir externally accessible.

15. The vehicle of claim 11, wherein the assembly of the ePTO system further comprises:
a heat exchanger mounted inside the housing, wherein the electric motor is mounted to a first side of the housing, wherein the heat exchanger is mounted to a first lateral side of the housing, and wherein the motor controller is mounted to a second lateral side of the housing opposite the first lateral side, such that the electric motor is interposed between the motor controller and the heat exchanger.

16. The vehicle of claim 15, wherein the assembly of the ePTO system further comprises:
a coolant pump mounted inside the housing, wherein the coolant pump is mounted to a second side of the housing opposite the first side.

17. The vehicle of claim 15, wherein the first side is a mounting side having a hole pattern that facilitates mounting the housing to the chassis.

18. The vehicle of claim 15, wherein the first lateral side has a plurality of louvers.

19. The vehicle of claim 11, wherein the assembly of the ePTO system further comprises:
a heat exchanger mounted inside the housing; and
a coolant reservoir mounted in the housing, wherein the coolant reservoir is mounted to the heat exchanger.

20. The vehicle of claim 11, wherein the housing has an opening through which a motor shaft of the electric motor extends to be coupled to the hydraulic pump mounted externally to the housing.
